(19) United States
(12) Patent Application Publication
(10) Pub. No.: US 2026/0034862 A1
(43) Pub. Date: Feb. 5, 2026

(54) TEMPERATURE ADJUSTMENT SYSTEM FOR ELECTRIC VEHICLE

(71) Applicant: Mazda Motor Corporation, Aki-gun (JP)

(72) Inventors: Shoko Horibata, Aki-gun (JP); Yuma Miyauchi, Aki-gun (JP)

(21) Appl. No.: 19/267,926

(22) Filed: Jul. 14, 2025

(30) Foreign Application Priority Data
Jul. 31, 2024 (JP) 2024-124226

(51) Int. Cl. B60H 1/32; B60H 1/00

(52) U.S. Cl. CPC B60H 1/3228; B60H 1/00278

(57) ABSTRACT

A temperature adjustment system for an electric vehicle includes: a compressor for compressing a first coolant containing CO₂; a first heat exchanger for cooling the compressed first coolant; cooling expansion valves for expanding the cooled first coolant; a coolant passage for supplying the expanded first coolant to an air conditioner; a coolant passage for supplying the expanded first coolant to a motor; a second heat exchanger for heat exchange between the first coolant and a second coolant that contains CO₂ and is sealed at least partially inside a battery case; a fan for circulating the second coolant such that heat is exchanged between a periphery of a cell and the second heat exchanger; a coolant passage for supplying the expanded first coolant to the second heat exchanger when cooling the battery; and coolant passages for supplying the first coolant to the compressor.

### TECHNICAL FIELD

The present disclosure relates to a temperature adjustment system for an electric vehicle.

### BACKGROUND ART

Conventionally, an air conditioning system having a thermal cycle circuit that operates with a coolant containing CO₂ (hereinafter referred to as a “CO₂ coolant” as appropriate) has been known. Moreover, a technology that thermally couples a thermal cycle circuit of an air conditioning system for a vehicle cabin of an electric vehicle with a battery to cool or heat the battery (for example, Japanese Unexamined Patent Application Publication No. 2011-68348), and a cooling system that directly cools a vehicle drive motor, an inverter, and a battery sealed in individual packages in a cooling unit by circulating a low-temperature CO₂ therein (for example, Japanese Unexamined Patent Application Publication No. 2009-107453), are being considered.

### SUMMARY

### Problems to be Solved

In recent years, the use of a CO₂ coolant for a vehicle-cabin air conditioning system is also being considered. In this case, it is conceivable that the CO₂ coolant used in the thermal cycle circuit of the vehicle-cabin air conditioning system may also be used for the temperature adjustment of the motor and the battery.

However, in general, the CO₂ coolant, whose pressure and temperature have been reduced by an expansion valve in the thermal cycle circuit of the air conditioning system, still has an extremely high pressure of about 5 MPa, and, if such a high-pressure CO₂ coolant is passed around a cell of the battery to cool the cell directly, it is necessary to strengthen the structures of the battery case and cell, which will increase the weight of the battery and raise manufacturing costs. On the other hand, in a case where the high-pressure CO₂ coolant is passed through a heat exchanger provided on the outside of the battery case to indirectly cool the cell inside the battery through the heat exchanger, the responsiveness of temperature control is slower compared to direct cooling, and, consequently, the range of battery temperature fluctuation increases, and battery deterioration due to the thermal cycle is more likely to occur.

The present disclosure has been made to solve such problems, and the purpose of the present disclosure is to provide a temperature adjustment system for an electric vehicle that can adjust the temperature of a battery with high responsiveness by a CO₂ coolant.

### Means For Solving the Problems

In order to solve the problems, the present disclosure provides a temperature adjustment system for an electric vehicle having an air conditioning unit for performing air conditioning, a drive motor, and a battery having a cell accommodated inside a battery case, the temperature adjustment system including: a compressor for compressing a first coolant containing CO₂; a first heat exchanger for cooling the first coolant compressed by the compressor; a first expansion valve for expanding the first coolant cooled by the first heat exchanger; an air-conditioning cooling path for supplying the first coolant expanded by the first expansion valve to the air conditioning unit when cooling the air conditioning unit; a motor cooling path for supplying the first coolant expanded by the first expansion valve to the motor when cooling the motor; a second heat exchanger for performing heat exchange between the first coolant and a second coolant that contains CO₂ and is sealed at least partially inside the battery case; a coolant circulation device for circulating the second coolant such that heat is exchanged between a periphery of the cell and the second heat exchanger; a battery cooling path for supplying the first coolant expanded by the first expansion valve to the second heat exchanger when cooling the battery; and a recovery path for supplying to the compressor, the first coolant that has passed through the air conditioning unit, the first coolant that has passed through the motor, and the first coolant that has passed through the second heat exchanger.

According to the present disclosure thus configured, since the cooling of the air conditioning unit, the cooling of the motor, and the cooling of the battery are performed using the shared first coolant containing CO₂, the overall configuration of the temperature adjustment system can be made compact. Moreover, since the second coolant that contains CO₂ and is sealed at least partially inside the battery case is cooled by the first coolant in the second heat exchanger and circulated such that heat is exchanged between the periphery of the cell and the second heat exchanger, the cell can be directly cooled using the low-pressure second coolant. Therefore, since there is no need to strengthen the structures of the cell and case of the battery, the temperature of the battery can be adjusted with high responsiveness, without causing an increase in the weight of the battery or a rise in manufacturing costs.

In the present disclosure, preferably, the coolant circulation device has a fan installed inside the battery case, the second heat exchanger is installed on a wall surface of the battery case, the fan circulates the second coolant in the battery case, and the second coolant is fully sealed within the battery case.

According to the present disclosure thus configured, the second coolant that is circulated inside the battery case by the fan is cooled or heated by exchanging heat with the first coolant when the second coolant flows along the second heat exchanger, and, thereafter, when the second coolant flows around the cell, the second coolant can directly cool or heat the cell. Consequently, the temperature of the battery can be adjusted with high responsiveness, without causing the increase in the weight of the battery or the rise in manufacturing costs.

In the present disclosure, preferably, the coolant circulation device has a second coolant path for providing fluid communication between an inside of the battery case and the second heat exchanger, and a pump for circulating the second coolant between the inside of the battery case and the second heat exchanger through the second coolant path, and the second coolant is further sealed within the second coolant path.

According to the present disclosure thus configured, the second coolant that is circulated between the inside of the battery case and the second heat exchanger by the pump is cooled or heated by exchanging heat with the first coolant when the second coolant passes through the second heat exchanger, and, thereafter, when the second coolant returns to the inside of the battery case and flows around the cell, the second coolant can directly cool or heat the cell. Consequently, the temperature of the battery can be adjusted with high responsiveness, without causing the increase in the weight of the battery or the rise in manufacturing costs.

In the present disclosure, preferably, the temperature adjustment system for the electric vehicle has a battery heating path for supplying the first coolant compressed by the compressor to the second heat exchanger when heating the battery.

According to the present disclosure thus configured, the high-temperature, high-pressure first coolant compressed by the compressor is supplied to the second heat exchanger, and the second coolant heated by the first coolant in the second heat exchanger can directly heat the cell when the second coolant flows around the cell. Consequently, the temperature of the battery can be adjusted with high responsiveness, without causing the increase in the weight of the battery or the rise in manufacturing costs.

In the present disclosure, preferably, the temperature adjustment system for the electric vehicle has an air-conditioning heating path for supplying the coolant compressed by the compressor to the air conditioning unit when heating the air conditioning unit.

According to the present disclosure thus configured, heating of the air conditioning unit can be performed by supplying the high-temperature, high-pressure coolant compressed by the compressor to the air conditioning unit through the air-conditioning heating path.

### Advantageous Effects

According to the temperature adjustment system for the electric vehicle of the present disclosure, the temperature of the battery can be adjusted with high responsiveness using the CO₂ coolant.

### BRIEF DESCRIPTION OF DRAWINGS

FIG. 1 is a schematic configuration diagram of a vehicle to which a temperature adjustment system for an electric vehicle according to an embodiment of the present disclosure is applied.

FIG. 2 is a schematic configuration diagram of the temperature adjustment system for the electric vehicle according to the embodiment of the present disclosure.

FIG. 3 is a block diagram showing an electrical configuration of the temperature adjustment system for the electric vehicle according to the embodiment of the present disclosure.

FIG. 4 is a flowchart of control to be executed by the temperature adjustment system for the electric vehicle according to the embodiment of the present disclosure.

FIG. 5 is an explanatory view showing the pressure-enthalpy (P-H) diagram and pressure-temperature (P-T) diagram of the thermal cycles of an air conditioner and a battery, and the flow of coolant when there are a cooling request for the air conditioner and a cooling request for the battery in the temperature adjustment system for the electric vehicle according to the embodiment of the present disclosure.

FIG. 6 is an explanatory view showing the P-H diagram and P-T diagram of the heating cycles of the air conditioner and the battery, and the flow of coolant when there are a heating request for the air conditioner and a heating request for the battery in the temperature adjustment system for the electric vehicle according to the embodiment of the present disclosure.

FIG. 7 is a schematic configuration diagram of a temperature adjustment system for an electric vehicle according to a second embodiment of the present disclosure.

### DETAILED DESCRIPTION

Hereinafter, a temperature adjustment system for an electric vehicle according to an embodiment of the present disclosure will be described with reference to the attached drawings.

### Overall Configuration

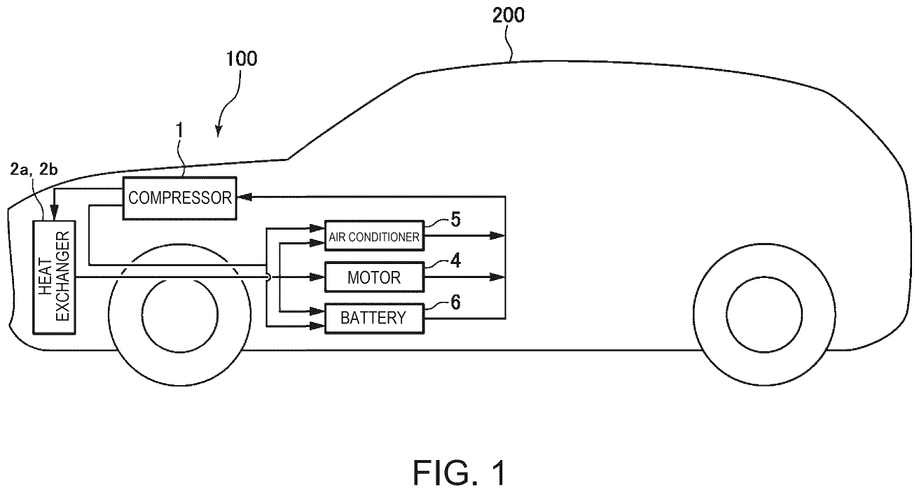

First, referring to FIG. 1, the overall configuration of the temperature adjustment system for the electric vehicle according to the present embodiment will be described. FIG. 1 is a schematic configuration diagram of a vehicle to which the temperature adjustment system for the electric vehicle according to the present embodiment is applied.

As shown in FIG. 1, an electric vehicle 200 has: a temperature adjustment system 100 with a thermal cycle circuit that operates with a coolant containing CO₂; a motor 4 for driving the electric vehicle 200; an air conditioner 5 (example of an air conditioning unit) for conditioning air in the electric vehicle 200; and a battery 6 for supplying electric power to the motor 4. Moreover, the temperature adjustment system 100 mainly includes a compressor 1 for compressing the coolant, and heat exchangers for performing heat exchange for the coolant.

The temperature adjustment system 100 circulates the CO₂ coolant as a natural coolant (which may be referred to simply as the “coolant” below). Typically, the CO₂ coolant is a coolant obtained by causing CO₂ to contain refrigerant oil such as polyalkylene glycol (PAG), and additives. In order to use such a CO₂ coolant, the compressor 1 is configured to compress the coolant to a very high pressure. The motor 4 uses the coolant, which has been compressed by the compressor 1 and cooled by a first heat exchanger 2a, to cool a rotor and a stator. Further, the motor 4 is configured such that a sliding bearing supporting a rotating shaft is lubricated by the coolant. Furthermore, the coolant which has been compressed by the compressor 1, or the coolant which has been cooled by at least one of the first heat exchanger 2a and a second heat exchanger 2b after being compressed, is used for air conditioning in the air conditioner 5, and for cooling or heating the battery 6.

### Configuration of Temperature Control System

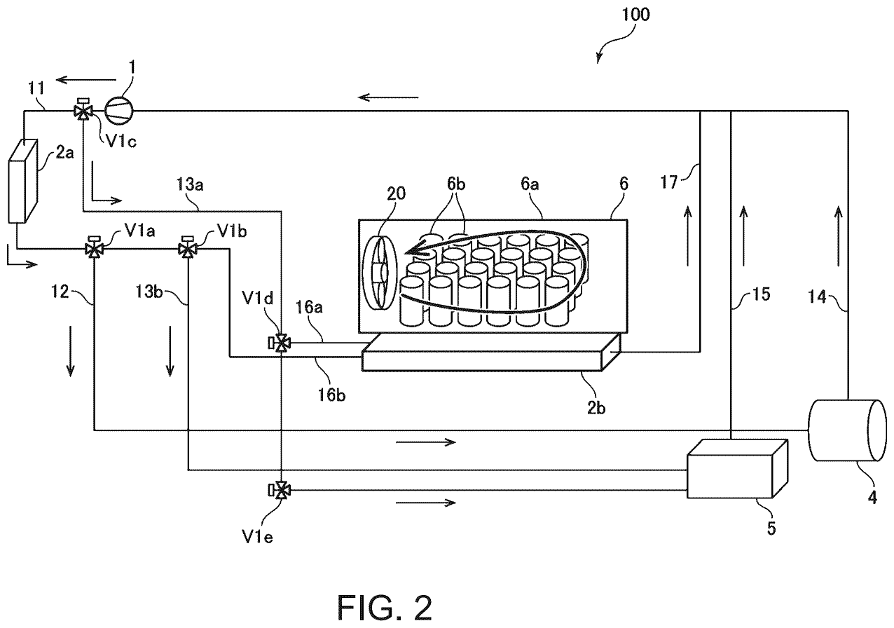

Next, referring to FIG. 2, the temperature adjustment system 100 according to the present embodiment will be specifically described. FIG. 2 is a schematic configuration diagram of the temperature adjustment system 100 according to the present embodiment.

The temperature adjustment system 100 constructs a thermal cycle circuit for circulating the CO₂ coolant as a first coolant, and includes, in addition to the compressor 1 and the heat exchangers 2a, 2b, coolant passages 11 to 17 through which the first coolant flows, cooling expansion valves V1a, V1b (examples of first expansion valves) for expanding the first coolant to decompress it, temperature-increasing valves V1d, V1e, and a heat exchanger bypass control valve V1c for switching the coolant passages.

In the present embodiment, the compressor 1 increases the pressure of the first coolant that has passed through the air conditioner 5, the first coolant that has passed through the motor 4, and the first coolant that has passed through the second heat exchanger 2b, from a pressure P2 to a pressure P1. In one example, the pressure P1 is about 11 MPa, and the pressure P2 is about 5 MPa.

The motor 4 is cooled by the temperature adjustment system 100. Specifically, the first coolant is compressed by the compressor 1, cooled through the first heat exchanger 2a via the coolant passage 11, further expanded by the cooling expansion valve V1a to a lower temperature, and supplied from the coolant passage 12 (example of a motor cooling path) to the motor 4. The first coolant supplied to the motor 4 cools the motor 4 by absorbing heat while passing through the stator, rotor, bearings, and the like of the motor 4, returns to the compressor 1 through the coolant passage 14 (example of a recovery path), and is compressed again.

The air conditioner 5 is cooled or heated by the temperature adjustment system 100. When cooling the air conditioner 5, the first coolant is compressed by the compressor 1, cooled through the first heat exchanger 2a via the coolant passage 11, further expanded by the cooling expansion valve V1b to a lower temperature than the air in a vehicle cabin, and then supplied from the coolant passage 13b (example of an air-conditioning cooling path) to the air conditioner 5. The coolant supplied to the air conditioner 5 absorbs heat while passing through an in-cabin heat exchanger of the air conditioner 5 to cool the air flowing into the vehicle cabin, returns to the compressor 1 through the coolant passage 15 (example of the recovery path), and is compressed again.

When heating the air conditioner 5, the first coolant is compressed to a high-temperature and a high pressure by the compressor 1 and expanded by the temperature-increasing valve V1e via the heat exchanger bypass control valve V1c and the coolant passage 13a (example of an air-conditioning heating path), and the first coolant having a higher temperature than the air in the vehicle cabin is supplied to the air conditioner 5. The first coolant supplied to the air conditioner 5 dissipates heat while passing through the in-cabin heat exchanger of the air conditioner 5 to heat the air flowing into the vehicle cabin, returns to the compressor 1 through the coolant passage 15, and is compressed again.

Further, in the present embodiment, the battery 6 has a battery case 6a, and cells 6b accommodated inside the battery case 6a. The battery case 6a is sealed, and the coolant containing CO₂ is sealed as a second coolant inside the battery case 6a. The second heat exchanger 2b is installed on a wall surface of the battery case 6a, and the first coolant is supplied to the second heat exchanger 2b from the coolant passage 16a (example of a battery heating path) or the coolant passage 16b (example of a battery cooling path). Consequently, heat exchange is performed between the first coolant and the second coolant inside the battery case 6a through the second heat exchanger 2b. Moreover, a fan 20 (example of a coolant circulation device) is installed inside the battery case 6a. The fan 20 circulates the second coolant within the battery case 6a such that heat is exchanged between the periphery of the cells 6b and the second heat exchanger 2b. In this configuration, the second coolant is fully sealed within the battery case 6a.

When cooling the battery 6, the first coolant is compressed by the compressor 1, cooled through the first heat exchanger 2a via the coolant passage 11, further expanded by the cooling expansion valve V1b to a lower temperature than the cells 6b, and supplied from the coolant passage 16b to the second heat exchanger 2b. The first coolant supplied to the second heat exchanger 2b absorbs heat while passing through the second heat exchanger 2b to cool the second coolant inside the battery case 6a, returns to the compressor 1 through the coolant passage 17 (example of the recovery path), and is compressed again. The second coolant that is circulated inside the battery case 6a by the fan 20 is cooled by exchanging heat with the first coolant when the second coolant flows along a periphery of the second heat exchanger 2b, and, thereafter, when the second coolant flows around the cells 6b, the second coolant cools the cells 6b by absorbing heat from the cells 6b.

When heating the battery 6, the first coolant is compressed by the compressor 1 and expanded by the temperature-increasing valve V1d via the heat exchanger bypass control valve V1c and the coolant passage 13a. At this time, the temperature of the first coolant is higher than the cells 6b. The first coolant expanded by the temperature-increasing valve V1d is supplied from the coolant passage 16a to the second heat exchanger 2b. The first coolant supplied to the second heat exchanger 2b dissipates heat while passing through the second heat exchanger 2b to heat the second coolant inside the battery case 6a, returns to the compressor 1 through the coolant passage 17, and is compressed again. The second coolant that is circulated inside the battery case 6a by the fan 20 is heated by exchanging heat with the first coolant when the second coolant flows along the periphery of the second heat exchanger 2b, and, thereafter, when the second coolant flows around the cells 6b, the second coolant heats the cells 6b by dissipating heat to the cells 6b.

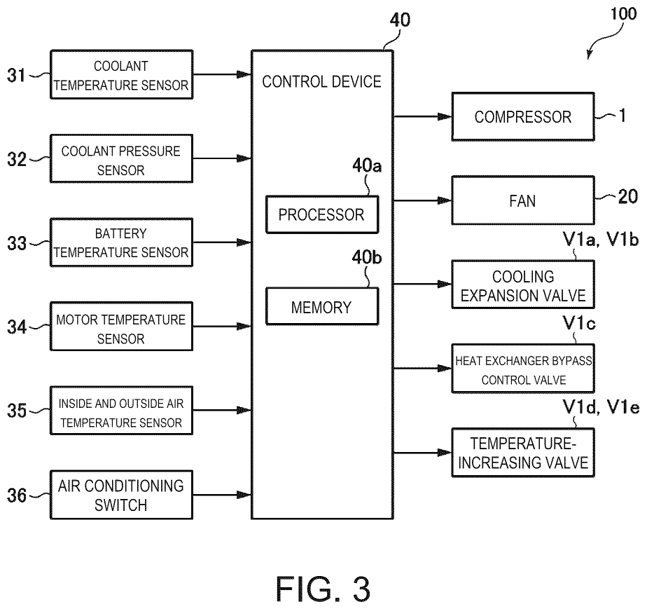

Next, referring to FIG. 2 and FIG. 3, an electrical configuration of the temperature adjustment system 100 according to the present embodiment will be described. FIG. 3 is a block diagram showing the electrical configuration of the temperature adjustment system 100 according to the present embodiment.

As shown in FIG. 3, the temperature adjustment system 100 has a control device 40 configured to perform various controls in the system. The control device 40 is configured with a computer having at least one processor 40a (typically a Central Processing Unit (CPU)), and memory 40b such as Read-Only Memory (ROM) or Random Access Memory (RAM) storing various kinds of programs, which are interpreted and executed on the processor 40a (including basic control programs such as an Operating System (OS), and application programs that are activated on the OS to realize specific functions), and various data.

Moreover, the temperature adjustment system 100 has: a coolant temperature sensor 31 for detecting the temperature of the coolant flowing through the coolant passages 11 to 17; a coolant pressure sensor 32 for detecting the pressure of the coolant; a battery temperature sensor 33 for detecting the temperature of the battery 6; a motor temperature sensor 34 for detecting the temperature of the motor 4; an inside and outside air temperature sensor 35 for detecting the air temperatures inside and outside the vehicle cabin of the electric vehicle 200; and an air conditioning switch 36 that accepts an operational input to the air conditioner 5. A plurality of coolant temperature sensors 31 and a plurality of coolant pressure sensors 32 can be installed at any location in the coolant passages 11 to 17.

The control device 40 outputs, based on signals input from the sensors 31 to 35 and the air conditioning switch 36, control signals to the compressor 1, the fan 20, the cooling expansion valves V1a, V1b, the heat exchanger bypass control valve V1c, and the temperature-increasing valves V1d, V1e to control them.

### Control

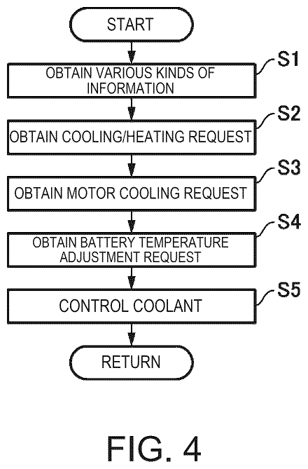

Next, referring to FIG. 4, the control performed by the control device 40 in the present embodiment will be described. FIG. 4 is a flowchart of control to be executed by the temperature adjustment system 100 for the electric vehicle according to the embodiment of the present disclosure.

The control shown in FIG. 4 is repeatedly executed at a predetermined cycle by the control device 40. Specifically, the processor 40a in the control device 40 reads out a program stored in the memory 40b, and executes the program to realize the control shown in the flowchart of FIG. 4.

When the control is started, in step S1, the control device 40 obtains various kinds of information such as detected values detected by the sensors 31 to 35, and an operational value input to the air conditioning switch 36.

Next, in step S2, the control device 40 obtains, based on the information obtained in step S1, a cooling/heating request for the air conditioner 5, that is, a required value for a cooling capability or a heating capability for the air conditioner 5 (for example, a flow rate of the coolant to be supplied to the air conditioner 5). For example, the required value for the cooling capability or heating capability for the air conditioner 5 is obtained according to the difference between a temperature set by the air conditioning switch 36 and the temperature in the vehicle cabin.

Next, in step S3, the control device 40 obtains, based on the information obtained in step S1, a cooling request for the motor 4, that is, a required value for a cooling capability for the motor 4 (for example, a flow rate of the coolant to be supplied to the motor 4). For example, the required value for the cooling capability for the motor 4 is obtained according to the difference between a preset reference temperature and the temperature of the motor 4 detected by the motor temperature sensor 34.

Next, in step S4, the control device 40 obtains, based on the information obtained in step S1, a temperature adjustment request for the battery 6, that is, a cooling or heating request for the battery 6. Specifically, in a situation in which the battery 6 needs to be cooled, for example, when the temperature of the battery 6 is higher than a preset reference temperature, the control device 40 obtains required values for cooling the battery 6 (for example, control values corresponding to opening the cooling expansion valve V1b, turning on the fan 20, and operating the compressor 1). In a situation in which the battery 6 needs to be heated, for example, when the temperature of the battery 6 is lower than the preset reference temperature, required values for heating the battery 6 (for example, control values corresponding to opening the heat exchanger bypass control valve V1c and temperature-increasing valve V1d, turning on the fan 20, and operating the compressor 1) are obtained.

Next, in step S5, the control device 40 executes control of the coolant flowing through the temperature adjustment system 100 (step S5), based on the cooling/heating request for the air conditioner 5 obtained in step S2, the cooling request for the motor 4 obtained in step S3, and the temperature adjustment request for the battery 6 obtained in step S4. In other words, the operations of the compressor 1, the fan 20, the cooling expansion valves V1a, V1b, the heat exchanger bypass control valve V1c, and the temperature-increasing valves V1d, V1e are controlled to correspond to the required value for the cooling capability or heating capability for the air conditioner 5, the required value for the cooling capability for the motor 4, and the required value for the cooling capability or heating capability for the battery 6. After step 5, the control device 40 ends the control.

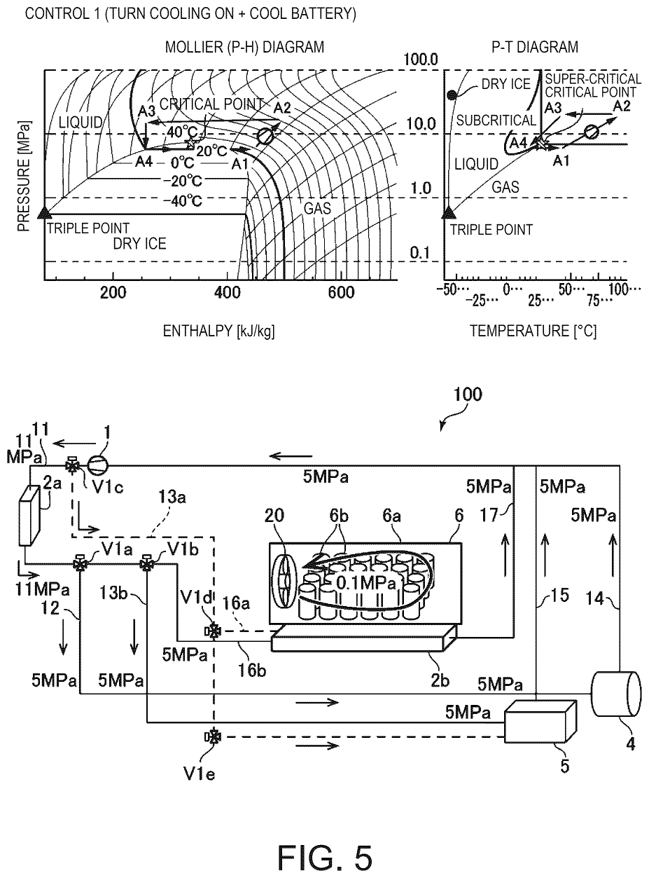

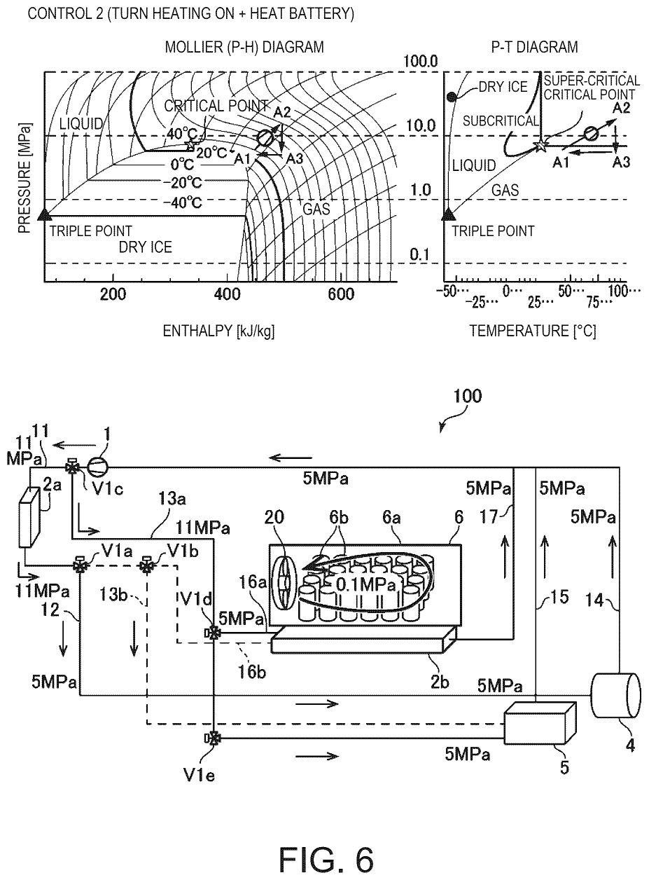

Next, referring to FIG. 5 and FIG. 6, one example of temperature adjustment control of the temperature adjustment system 100 according to the embodiment of the present disclosure will be described. The upper side in each of FIG. 5 and FIG. 6 shows the pressure-enthalpy (P-H) diagram and pressure-temperature (P-T) diagram of cooling or heating cycles of the air conditioner 5 and the battery 6 in each control pattern, and the lower side shows thermal cycle circuits of the temperature adjustment system 100 in each control pattern. In the thermal cycle circuits of FIG. 5 and FIG. 6, the solid lines indicate coolant passages through which the coolant flows, and the dashed lines indicate coolant passages through which the coolant does not flow.

### Control 1

FIG. 5 is an explanatory view showing the P-H diagram and P-T diagram of the cooling cycles of the air conditioner 5 and the battery 6, and the flow of coolant when there is a cooling request for the air conditioner 5 and a cooling request for the battery 6.

In the control 1 shown in FIG. 5, a thermal cycle circuit for cooling the motor 4, a thermal cycle circuit for performing cooling by the air conditioner 5, and a thermal cycle circuit for cooling the battery 6 through the second heat exchanger 2b are formed in the temperature adjustment system 100.

Of these thermal cycle circuits, in the thermal cycle circuit for cooling the motor 4, the first coolant is compressed by the compressor 1 to a high temperature and a high pressure (about 120° C. and 11 MPa in the example of FIG. 5), cooled (about 30° C. in the example of FIG. 5) through the first heat exchanger 2a via the coolant passage 11, further expanded isenthalpically by the cooling expansion valve V1a to a lower temperature (about 20° C. and 5 MPa in the example of FIG. 5), and supplied from the coolant passage 12 to the motor 4. The first coolant supplied to the motor 4 cools the motor 4 by absorbing heat while passing through the stator, rotor, bearings, and the like of the motor 4, returns to the compressor 1 through the coolant passage 14, and is compressed again.

In the thermal cycle circuit for performing cooling by the air conditioner 5, the first coolant is compressed by the compressor 1 to a high temperature and a high pressure (about 120° C., 11 Mpa in the example of FIG. 5, and a point A2 on the P-H diagram and the P-T diagram), cooled (about 30° C. in the example of FIG. 5, and a point A3 on the P-H diagram and the P-T diagram) through the first heat exchanger 2a via the coolant passage 11, further expanded isenthalpically by the cooling expansion valve V1b to a lower temperature (about 20° C., 5 MPa in the example of FIG. 5, and a point A4 on the P-H diagram and the P-T diagram), and supplied from the coolant passage 13b (example of the motor cooling path) to the air conditioner 5. The first coolant supplied to the air conditioner 5 absorbs heat while passing through the in-cabin heat exchanger of the air conditioner 5 to cool the air flowing into the vehicle cabin, returns to the compressor 1 through the coolant passage 15 (about 30° C., 5 MPa in the example of FIG. 5, and a point A1 on the P-H diagram and the P-T diagram), and is compressed again.

In the thermal cycle circuit for cooling the battery 6, the first coolant is compressed by the compressor 1 to a high temperature and a high pressure (about 120° C., 11 Mpa in the example of FIG. 5, and the point A2 on the P-H diagram and the P-T diagram), cooled (about 30° C. in the example of FIG. 5, and the point A3 on the P-H diagram and the P-T diagram) through the first heat exchanger 2a via the coolant passage 11, further expanded isenthalpically by the cooling expansion valve V1b to a lower temperature (about 20° C., 5 MPa in the example of FIG. 5, and the point A4 on the P-H diagram and the P-T diagram) than the cells 6b, and supplied from the coolant passage 16b to the second heat exchanger 2b. The first coolant supplied to the second heat exchanger 2b absorbs heat while passing through the second heat exchanger 2b to cool the second coolant inside the battery case 6a, returns to the compressor 1 through the coolant passage 17 (about 30° C., 5 MPa in the example of FIG. 5, and the point A1 on the P-H diagram and the P-T diagram), and is compressed again. The second coolant (0.1 Mpa in the example of FIG. 5) that is circulated inside the battery case 6a by the fan 20 is cooled by exchanging heat with the first coolant when the second coolant flows along the periphery of the second heat exchanger 2b, and, thereafter, when the second coolant flows around the cells 6b, the second coolant cools the cells 6b by absorbing heat from the cells 6b.

### Control 2

FIG. 6 is an explanatory view showing the P-H diagram and P-T diagram of the heating cycles of the air conditioner 5 and the battery 6, and the flow of coolant when there is a heating request for the air conditioner 5 and a heating request for the battery 6.

In the control 2 shown in FIG. 6, a thermal cycle circuit for cooling the motor 4, a thermal cycle circuit for performing cooling by the air conditioner 5, and a thermal cycle circuit for cooling the battery 6 through the heat exchanger 2b are formed in the temperature adjustment system 100. Of these thermal cycle circuits, the thermal cycle circuit for cooling the motor 4 is the same as that in the control 1.

Moreover, in the thermal cycle circuit for performing heating by the air conditioner 5, the first coolant is compressed by the compressor 1 to a high temperature and a high pressure (about 120° C., 11 MPa in the example of FIG. 6, and the point A2 on the P-H diagram and the P-T diagram) and expanded by the temperature-increasing valve V1e via the heat exchanger bypass control valve V1c and the coolant passage 13a, and the first coolant having a higher temperature (about 60° C., 5 MPa in the example of FIG. 6, and the point A3 on the P-H diagram and the P-T diagram) than the air in the vehicle cabin is supplied from the coolant passage 13a to the air conditioner 5. The first coolant supplied to the air conditioner 5 dissipates heat while passing through the in-cabin heat exchanger of the air conditioner 5 to heat the air flowing into the vehicle cabin, returns to the compressor 1 through the coolant passage 15 (about 30° C., 5 MPa in the example of FIG. 6, and the point A1 on the P-H diagram and the P-T diagram), and is compressed again.

Further, in the thermal cycle circuit for heating the battery 6, the first coolant is compressed by the compressor 1 to a high temperature and a high pressure (about 120° C., 11 MPa in the example of FIG. 6, and the point A2 on the P-H diagram and the P-T diagram), and expanded by the temperature-increasing valve V1d via the heat exchanger bypass control valve V1c and the coolant passage 13a. At this time, the temperature of the first coolant is higher than the cells 6b (about 60° C., 5 MPa in the example of FIG. 6, and the point A3 on the P-H diagram and the P-T diagram). The first coolant expanded by the temperature-increasing valve V1d is supplied from the coolant passage 16a to the second heat exchanger 2b. The first coolant supplied to the second heat exchanger 2b dissipates heat while passing through the second heat exchanger 2b to heat the second coolant inside the battery case 6a, returns to the compressor 1 through the coolant passage 17 (about 30° C., 5 MPa in the example of FIG. 6, and the point A1 on the P-H diagram and the P-T diagram), and is compressed again. The second coolant that is circulated inside the battery case 6a by the fan 20 is heated by exchanging heat with the first coolant when the second coolant flows along the periphery of the second heat exchanger 2b, and, thereafter, when the second coolant flows around the cells 6b, the second coolant heats the cells 6b by dissipating heat to the cells 6b.

In addition to the control 1 and control 2, the temperature adjustment system 100 can execute controls corresponding to a case where there is a heating request for the air conditioner 5 and a cooling request for the battery 6, a case where there is no cooling/heating request for the air conditioner 5 (that is, the air conditioner 5 is off) and there is a cooling or heating request for the battery 6, a case where there is a dry-heating request for the air conditioner 5 and a cooling or heating request for the battery 6. Under these controls, similarly to the control 1 and control 2, by forming thermal cycle circuits corresponding to a temperature adjustment request for the air conditioner 5 and a temperature adjustment request for the battery 6, the control corresponding to the temperature adjustment requests can be executed.

### Second Embodiment

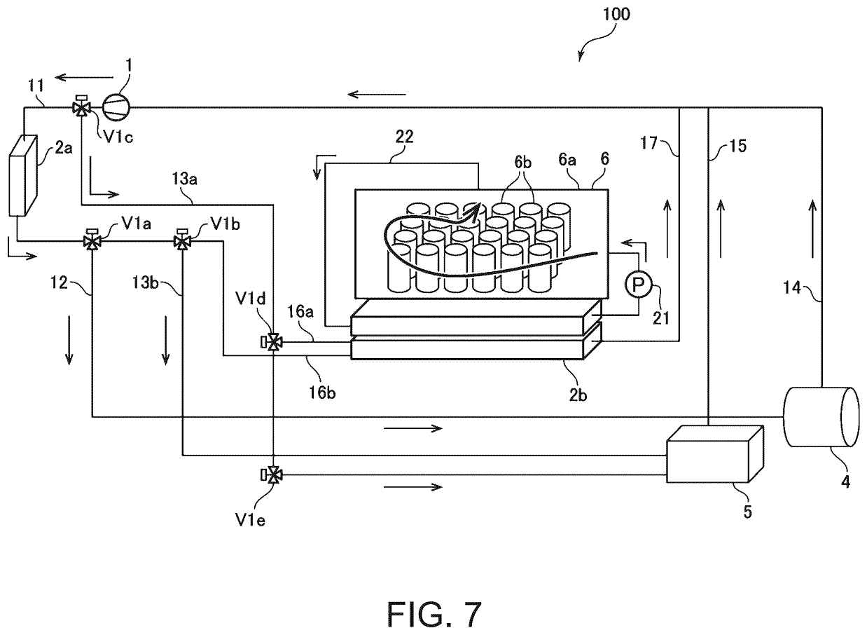

Next, referring to FIG. 7, a temperature adjustment system 100 according to a second embodiment will be described. FIG. 7 is a schematic configuration diagram of the temperature adjustment system 100 according to the second embodiment.

In the temperature adjustment system 100 of the second embodiment, the configuration of the coolant circulation device for circulating the second coolant between the periphery of the cells 6b and the second heat exchanger 2b differs from that of the above-described embodiment shown in FIG. 2.

Specifically, as shown in FIG. 7, the fan 20 is not provided inside the battery case 6a in the second embodiment. Moreover, the second heat exchanger 2b does not necessarily need to be installed on the wall surface of the battery case 6a.

On the other hand, in the second embodiment, a coolant passage 22 (second coolant path) for providing fluid communication between the inside of the battery case 6a and the second heat exchanger 2b, and a pump 21 for circulating the second coolant between the inside of the battery case 6a and the second heat exchanger 2b through the coolant passage 22 are provided as the coolant circulation device. In other words, the first coolant and the second coolant are supplied to the second heat exchanger 2b to exchange heat with each other inside the second heat exchanger 2b.

When cooling the battery 6, the first coolant is compressed by the compressor 1, cooled through the first heat exchanger 2a via the coolant passage 11, further expanded by the cooling expansion valve V1b to a lower temperature than the cells 6b, and supplied from the coolant passage 16b to the second heat exchanger 2b. The first coolant supplied to the second heat exchanger 2b absorbs heat while passing through the second heat exchanger 2b to cool the second coolant flowing through the second heat exchanger 2b, returns to the compressor 1 through the coolant passage 17, and is compressed again. The second coolant that is pressure-fed by the pump 21 to circulate between the inside of the battery case 6a and the second heat exchanger 2b is cooled by exchanging heat with the first coolant when passing through the second heat exchanger 2b, and then returns to the inside of the battery case 6a and cools the cells 6b by absorbing heat from the cells 6b when the second coolant flows around the cells 6b. In this configuration, the second coolant is sealed within the battery case 6a and the coolant passage 22.

When heating the battery 6, the first coolant is compressed by the compressor 1 and expanded by the temperature-increasing valve V1d via the heat exchanger bypass control valve V1c and the coolant passage 13a. At this time, the temperature of the first coolant is higher than the cells 6b. The first coolant expanded by the temperature-increasing valve V1d is supplied from the coolant passage 16a to the second heat exchanger 2b. The first coolant supplied to the second heat exchanger 2b dissipates heat while passing through the second heat exchanger 2b to heat the second coolant flowing through the second heat exchanger 2b, returns to the compressor 1 through the coolant passage 17, and is compressed again. The second coolant that is pressure-fed by the pump 21 to circulate between the inside of the battery case 6a and the second heat exchanger 2b is heated by exchanging heat with the first coolant when passing through the second heat exchanger 2b, and then returns to the inside of the battery case 6a and heats the cells 6b by dissipating heat to the cells 6b when the second coolant flows around the cells 6b.

Note that the temperature adjustment controls and the thermal cycle circuits of the temperature adjustment system 100 according to the second embodiment can be configured in the same manner as those explained in the above-described embodiment.

### Functions and Effects

Next, functions and effects of each temperature adjustment system for an electric vehicle of the above-described embodiment and the second embodiment will be explained.

According to the temperature adjustment system 100 of the present embodiment, since the cooling of the air conditioner 5, the cooling of the motor 4, and the cooling of the battery 6 are performed using the shared first coolant containing CO₂, the overall configuration of the temperature adjustment system 100 can be made compact. Moreover, since the second coolant that contains CO₂ and is sealed at least partially inside the battery case 6a is cooled by the first coolant in the second heat exchanger 2b and circulated such that heat is exchanged between the periphery of the cells 6b and the second heat exchanger 2b, the cells 6b can be directly cooled using the low-pressure second coolant. Therefore, since there is no need to strengthen the structures of the cells 6b and the battery case 6a of the battery 6, the temperature of the battery 6 can be adjusted with high responsiveness, without causing an increase in the weight of the battery 6 or a rise in manufacturing costs.

Further, the second coolant that is circulated inside the battery case 6a by the fan 20 is cooled or heated by exchanging heat with the first coolant when the second coolant flows along the second heat exchanger 2b, and, thereafter, when the second coolant flows around the cells 6b, the second coolant can directly cool or heat the cells 6b. Consequently, the temperature of the battery 6 can be adjusted with high responsiveness, without causing the increase in the weight of the battery 6 or the rise in manufacturing costs.

Furthermore, the second coolant that is circulated by the pump 21 such that heat is exchanged between the inside of the battery case 6a and the second heat exchanger 2b is cooled or heated by exchanging heat with the first coolant when the second coolant passes through the second heat exchanger 2b or a periphery thereof, and, thereafter, when the second coolant flowing through the inside of the battery case 6a flows around the cells 6b, the second coolant can directly cool or heat the cells 6b. Consequently, the temperature of the battery 6 can be adjusted with high responsiveness, without causing the increase in the weight of the battery 6 or the rise in manufacturing costs.

Moreover, the high-temperature, high-pressure first coolant compressed by the compressor 1 is supplied to the second heat exchanger 2b, and the second coolant that is heated by the first coolant in the second heat exchanger 2b can directly heat the cells 6b when the second coolant flows around the cells 6b. Consequently, the temperature of the battery 6 can be adjusted with high responsiveness, without causing the increase in the weight of the battery 6 or the rise in manufacturing costs.

Furthermore, by supplying the high-temperature, high-pressure coolant compressed by the compressor 1 to the air conditioner 5 through the coolant passage 13a, heating of the air conditioner 5 can be performed.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### REFERENCE CHARACTER LIST

1 Compressor
2a First heat exchanger
2b Second heat exchanger
4 Motor
5 Air conditioner
6 Battery
6a Battery case
6b Cell
11-17 Coolant passage
20 Fan
21 Pump
22 Coolant passage
31 Coolant temperature sensor
32 Coolant pressure sensor
33 Battery temperature sensor
34 Motor temperature sensor
35 Inside and outside air temperature sensor
36 Air conditioning switch
40 Control device
100 Temperature adjustment system
200 Electric vehicle

V1a, V1b Cooling expansion valve

V1c Heat exchanger bypass control valve
V1d, V1e Temperature-increasing valve

1. A temperature adjustment system for an electric vehicle having an air conditioning unit for performing air conditioning, a drive motor, and a battery having a cell accommodated inside a battery case, the temperature adjustment system comprising:
a compressor for compressing a first coolant containing CO₂;
a first heat exchanger for cooling the first coolant compressed by the compressor;
a first expansion valve for expanding the first coolant cooled by the first heat exchanger;
an air-conditioning cooling path for supplying the first coolant expanded by the first expansion valve to the air conditioning unit when cooling the air conditioning unit;
a motor cooling path for supplying the first coolant expanded by the first expansion valve to the motor when cooling the motor;
a second heat exchanger for performing heat exchange between the first coolant and a second coolant that contains CO₂ and is sealed at least partially inside the battery case;
a coolant circulation device for circulating the second coolant such that heat is exchanged between a periphery of the cell and the second heat exchanger;
a battery cooling path for supplying the first coolant expanded by the first expansion valve to the second heat exchanger when cooling the battery; and
a recovery path for supplying to the compressor, the first coolant that has passed through the air conditioning unit, the first coolant that has passed through the motor, and the first coolant that has passed through the second heat exchanger.

2. The temperature adjustment system for the electric vehicle according to claim 1, wherein
the coolant circulation device has a fan installed inside the battery case,
the second heat exchanger is installed on a wall surface of the battery case,
the fan circulates the second coolant in the battery case, and
the second coolant is fully sealed within the battery case.

3. The temperature adjustment system for the electric vehicle according to claim 1, wherein the coolant circulation device has a second coolant path for providing fluid communication between an inside of the battery case and the second heat exchanger, and a pump for circulating the second coolant between the inside of the battery case and the second heat exchanger through the second coolant path, and the second coolant is further sealed within the second coolant path.

4. The temperature adjustment system for the electric vehicle according to claim 1, comprising a battery heating path for supplying the first coolant compressed by the compressor to the second heat exchanger when heating the battery.

5. The temperature adjustment system for the electric vehicle according to claim 2, comprising a battery heating path for supplying the first coolant compressed by the compressor to the second heat exchanger when heating the battery.

6. The temperature adjustment system for the electric vehicle according to claim 3, comprising a battery heating path for supplying the first coolant compressed by the compressor to the second heat exchanger when heating the battery.

7. The temperature adjustment system for the electric vehicle according to claim 1, comprising an air-conditioning heating path for supplying the first coolant compressed by the compressor to the air conditioning unit when heating the air conditioning unit.

8. The temperature adjustment system for the electric vehicle according to claim 2, comprising an air-conditioning heating path for supplying the first coolant compressed by the compressor to the air conditioning unit when heating the air conditioning unit.

9. The temperature adjustment system for the electric vehicle according to claim 3, comprising an air-conditioning heating path for supplying the first coolant compressed by the compressor to the air conditioning unit when heating the air conditioning unit.
